(19) United States
(12) Patent Application Publication
(10) Pub. No.: US 2004/0215579 A1
(43) Pub. Date: Oct. 28, 2004

(54) Supplemental address verification

(76) Inventors: George Redenbaugh, San Jose, CA (US); Juanjuan Xu, Cupertino, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/422,337

(22) Filed: Apr. 24, 2003

(51) Int. Cl. G06F 17/60

(52) U.S. Cl. 705/78

(57) ABSTRACT

In an embodiment, an apparatus for supplemental address verification for fraud prevention, includes: a validation tool configured to receive an incoming order from a customer and to validating a credit card of the customer with an issuing financial institution; a fraud shield tool configured to compare information related to the incoming order with negative files; an electronic commerce rule-based fraud detection tool configured to compare information related to the incoming order with general fraud patterns; and a third-party service configured to further analyze the incoming order for potential fraud, if an outsort rule fires.

### TECHNICAL FIELD

Embodiments of the present invention relate generally to the fraud prevention methods. More particularly, embodiments of the present invention related to method and apparatus for supplemental address verification.

### BACKGROUND

An incoming order (e.g., an order for a particular product or service) may be placed by a customer via an online shopping website or via a call-center. One example of an online shopping website is the HPShopping website from HEWLETT-PACKARD COMPANY, Palo Alto, Calif., at <www.hpshopping.com>. Currently, when an incoming order is made by a customer, the incoming order will be reviewed for potential fraud by having an analyst examine the dollar amount of the incoming order. As a result, this current method is unable to detect for fraudulent orders that may have lower dollar amounts.

Currently, some online shopping websites, such as the above-noted HPShopping website, use the Address Verification Service (AVS) which is provided by, for example, VISA, MASTERCARD, and AMERICAN EXPRESS to verify the billing information provided by customers of the website. The AVS service matches the billing information provided by the customer with the billing information that is on file with the AVS. This AVS file information is typically supplied by sponsoring banks. However, the AVS service has become an increasingly unreliable tool to accurately screen fraudulent orders and verify the correct billing addresses of customers. In particular, AVS address mis-match errors occur in about 3.5% of attempted transactions on average with periodic spikes in which up to about 13% of attempted transactions have been rejected. This has resulted in an increase in the call volumes to call-centers, a high number of orders that require manual review (which negatively impact the customer's shopping experience), an increased cost associated with the order manual review, and lost sales due to customer frustration.

Therefore, the current technology in verifying the customer billing information and identity is limited in its capabilities and suffers from at least the above deficiencies.

### SUMMARY OF EMBODIMENTS OF THE INVENTION

In an embodiment of the invention, a method for supplemental address verification for fraud prevention, includes: receiving an incoming order from a customer; validating a credit card of the customer with an issuing financial institution; comparing information related to the incoming order with negative files; comparing information related to the incoming order with general fraud patterns; and if an outsort rule fires, then using a third-party service to further analyze the incoming order for potential fraud.

In another embodiment, an apparatus for supplemental address verification for fraud prevention, includes: a validation tool configured to receive an incoming order from a customer and to validating a credit card of the customer with an issuing financial institution; a fraud shield tool configured to compare information related to the incoming order with negative files; an electronic commerce rule-based fraud detection tool configured to compare information related to the incoming order with general fraud patterns; and a third-party service configured to further analyze the incoming order for potential fraud, if an outsort rule fires.

In another embodiment, an article of manufacture, includes: a machine-readable medium having stored thereon instructions to: receive an incoming order from a customer; validate a credit card of the customer with an issuing financial institution; compare information related to the incoming order with negative files; compare information related to the incoming order with general fraud patterns; and use a third-party service to further analyze the incoming order for potential fraud, if an outsort rule fires.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a block diagram that show additional details of the apparatus of FIG. 1, in accordance with an embodiment of the invention.

FIG. 3 is another block diagram that show additional details of the apparatus of FIG. 1, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

Embodiments of the invention advantageously provide an apparatus, system, and method that verify particular information for an incoming order by providing a real-time authentication of the customer information and by reducing the need for manual authentication of the customer and for manual screening of fraudulent transactions. Embodiments of the invention advantageously lower the cost and decreases the processing time that are required in the fraud screening process for customer orders. Embodiments of the invention also advantageously reduce the call center traffic that is related to AVS mismatches.

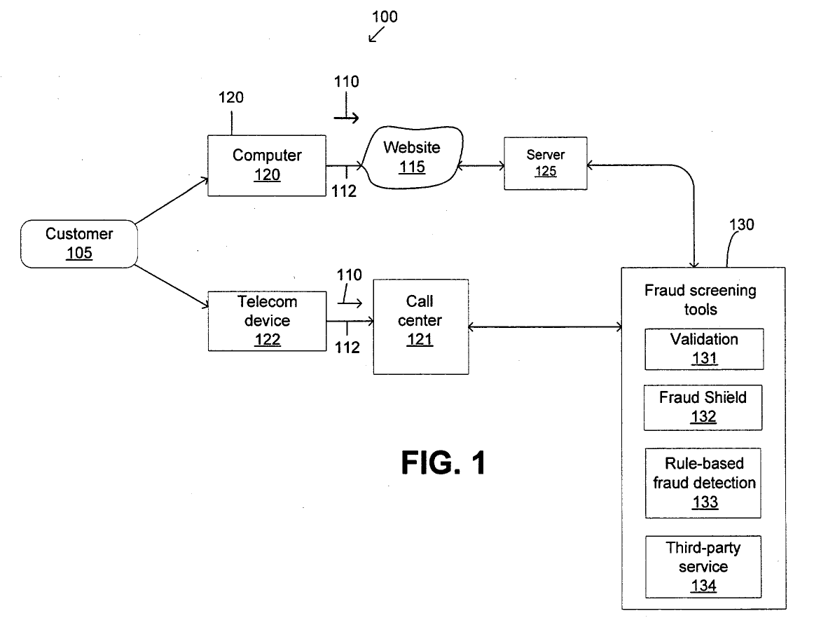

FIG. 1 is a block diagram of a system (or apparatus) 100 in accordance with an embodiment of the invention. A customer 105 may send an order 110 via a network 112 to an online shopping website 115 or may send the order 110 by calling a call-center 121. The order 110 may be, for example, an order for a particular product(s) and/or service(s). The online shopping website 115 may be, for example, an online shopping website provided by HEWLETT-PACKARD COMPANY at <www.HPShopping.com>, other online shopping websites from other vendors or companies, an internal company shopping website, or another type of online shopping website. The network 112 may be any suitable communication network such as, for example, a wide area network (e.g., the Internet) or a local area network (LAN) or a telephone communication network.

Typically, to send an order 110 to the online shopping website 115, the customer 105 will use a computer 120 to access and place the order 110 on the website 115. Typically, a server 125 (or other suitable computing device) is used to implement the website 115 and to receive and process the order 110 from the customer 105. An embodiment of the invention provides a system 100 that permits the operator of the website 115 to determine if the customer 105 is sending an order(s) 110 that may be fraudulent. The system 100 can, therefore, reduce fraud and improve accuracy of fraud screening for transactions in the online shopping website 115.

The server 125 includes a processor (not shown in FIG. 1) for executing various applications or programs in the server 125. Similarly, the computer 120 will also include a processor (not shown in FIG. 1) for executing various applications or programs in the computer 120. Various known components that are used in the server 125 and in the computer 120 are not shown in FIG. 1 for purposes of focusing on the functionalities of embodiments of the invention.

Typically, to send an order 110 to the call center 121, the customer 105 will use a telecommunication (telecom) device 122 (e.g., telephone or cellular phone) to place the order 110 to the call center 121. An embodiment of the invention provides a system 100 that permits the operator of the call center 121 to determine if the customer 105 is sending an order(s) 110 that may be fraudulent.

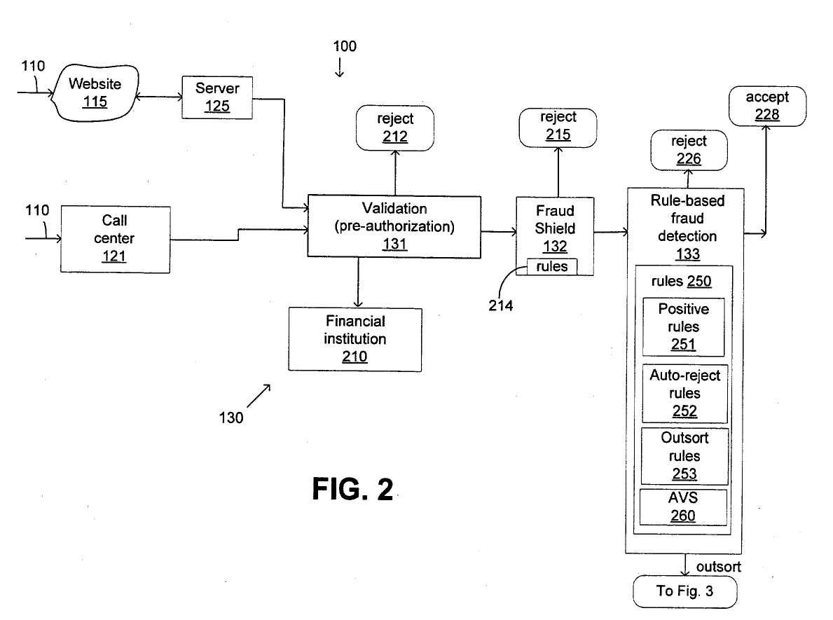

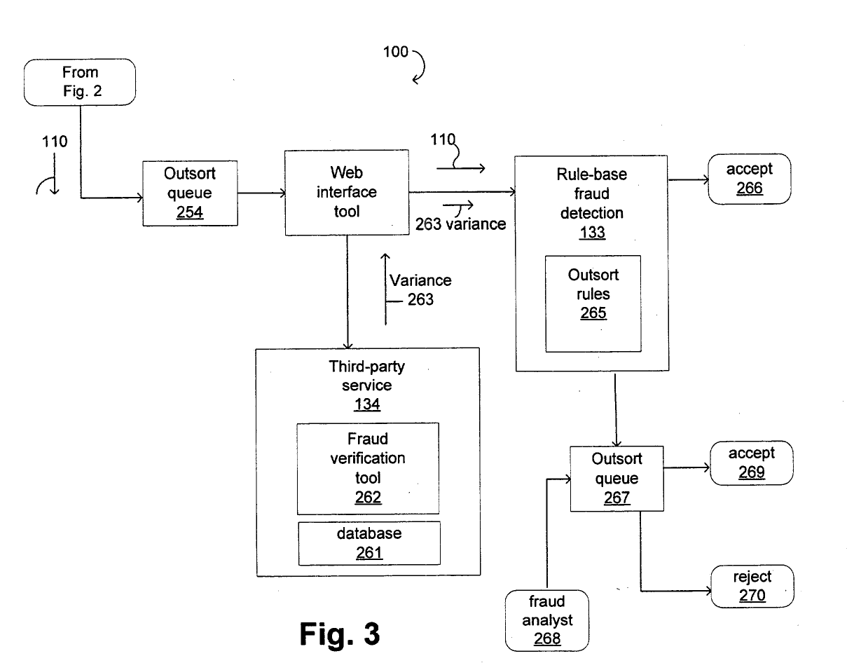

The system 100 includes fraud screening tools (generally referred to as tools 130 that can function with the server 125 and the call center 121 to determine if an order 110 should be accepted or rejected and to determine if the order 110 may potentially be a fraudulent order. In one embodiment the fraud screening tools 130 includes a validation tool 131, fraud shield tool 132, an electronic commerce rule-based fraud detection tool 133 and third-party service 134. It is noted that some of the tools 130 can also be accessed by the call center 121 and server 125 by use of the network 112. Examples and the functions of these fraud screening tools are described further below with reference to FIG. 2 and FIG. 3.

FIG. 2 is a functional block diagram illustrating additional details of the system 100 for performing fraud screening for an incoming order 105, in accordance with an embodiment of the invention. An incoming order 110 may be an order coming via the call center 121 or an order coming via the online shopping website 121. In an embodiment, the fraud screening tools 130 will function as discussed below. The validation tool 131 sends a request for a pre-authorization from a financial institution 210 such as the issuing bank of the credit card that is used by the customer to determine if the customer 105 has sufficient available funds in his/her credit card. The validation tool 131 may comprise a computer or telecommunication equipment that the fraud analyst uses to contact the financial institution for pre-authorization. If pre-authorization is declined, then the order is automatically rejected (212). Pre-authorization may be declined by the financial institution if, for example, the customer for the incoming order 110 does not have enough funds in the issuing bank to pay for the incoming order 110.

On the other hand, if the pre-authorization is received from the financial institution 210, then the fraud shield tool 132 will apply fraud shield rules 214 to the incoming order 110. A suitable fraud shield tool 132 is of the type available from, for example, ClearCommerce Corporation, Austin, Tex. A fraud shield tool stores negative files (e.g., a particular address and/or phone number associated with a past known fraudulent order). A fraud shield rule 214 will fire (trigger) if the incoming order 110 (and/or the customer 105 of the order 110) has information matching information in the negative files. If a fraud shield rule 214 fires, then the order is automatically rejected (215).

If a fraud shield rule 214 does not fire, then the electronic commerce rule-based fraud detection tool 133 checks the order 110 based on a set of rules 250. The fraud detection tool 133 may be, for example, of the type such as the eFalcon product which is an e-commerce fraud detection product from Fair, Issac and Company, San Rafael, Calif. The fraud detection tool 133 compares the information that is provided by the customer 105 who placed the order 110. The eFalcon product compares the transaction to general fraud patterns. The eFalcon product can also compare the transaction to individual cardholder profiles to see where the transaction is consistent with the typical behavior of the individual. The eFalcon product will provide a score that may be used as fraud probability information that can be used to decide if the transaction should be accepted or rejected.

If a “positive rule” 251 fires after the rule-based fraud detection tool 133 performs the analysis, then the order is automatically accepted (228). A positive rule permits an order 110 to be automatically accepted, since the event associated with the triggering of the positive rule 251 makes it very unlikely that a fraudulent activity is associated with the incoming order. For example, a positive rule 251 is triggered if the incoming order 110 is made from an internal website of the vendor associated with the website or call-center (e.g., an order for a HEWLLET-PACKARD product is made from a HEWLLET-PACKARD employee internal website). As another example, if the credit card number (that is used to for the incoming order 110) belongs to a customer satisfaction group (or other pre-selected group) of the vendor, then a positive rule is triggered, where the customer satisfaction group orders replacement products for the vendor. As another example, if the incoming order 110 is made by a trusted customer, then a positive rule 251 is triggered. Activities from these pre-selected groups that trigger a positive rule 251 are unlikely related to fraudulent activities. Other suitable events or groups of customers can be associated with the firing of a positive rule(s) 251 by the rule-based fraud detection tool 133.

An automatic-reject rule 252 identifies a likelihood of fraudulent activity with the incoming order 110. If one of the automatic-reject rules 252 fires in the rule-based fraud detection tool 133, then the incoming order is automatically rejected (226).

On the other hand, if an outsort rule 253 fires in the rule-based fraud detection tool 133, then the order 110 is placed in an outsort queue 254 as shown in FIG. 3. Various examples are described below on indicators that will fire an outsort rule 253.

It is noted that the rules 251, 252, and 253 are shown as separate blocks in FIG. 2 for purposes of describing the functionalities of embodiments of the invention. It is also within the scope of embodiments of the invention to integrate the rules 251, 252, and 253 into various combinations in order to provide the rule functions described above.

An address verification system (AVS) check can be performed by use of the AVS service 260. The AVS service 260 is used to verify the credit-card holder's address and zip code at the time of the transaction, and to verify if the information that the cardholder has entered matches the information that is stored at the issuing bank. The AVS service 260 can also verify if the credit card of the customer 105 is a foreign credit card.

In an embodiment of the invention, an outsort rule 253 will fire if the address information provided by the customer 105 does not match the address information that is on file with an AVS service 260. This AVS file information is typically supplied by sponsoring banks. In another embodiment of the invention, if the address information provided by the customer 105 does not match the address information that is on file with the AVS service 260, then the order 110 is rejected (226).

Other outsort rules 253 can be set in the rule-based fraud detection tool 133. For example, if the address information provided by the customer 105 matches the address information that is on file with an AVS service 260, but the shipping address and the billing address of the customer 105 does not match and if the ordered item is being shipped to an area where there has been previous fraud-related activities, then the outsort rules 253 will fire and the order 110 will be placed in the outsort queue 254. Therefore, an address match with the AVS file information may just be one factor to determine if an order will be placed in the outsort queue 254.

If the outsort rule 253 fires, then the third-party service 134 is used to further analyze the order 110 for potential fraud. In an embodiment, a web interface tool 255 is used to access the third-party service 134.

In an embodiment, the third-party service 134 is of the type available from, for example, EXPERIAN, Costa Mesa, Calif. <www.experian.com> or may be other suitable customer verification tools or services. The EXPERIAN service insures the accuracy of customer information, and uses a powerful database 261 of, for example, 150 million consumers and 25 million businesses to instantly verify customer data. The information provided by the customer 105 can be matched with the information in the database 261. A fraud verification tool 262 in the third-party service can then provide a variance value 263 that is indicative of the variance between the information provided by the customer 105 and the information in the database 261. For example, if the customer 105 provided his/her information as “Bill Smith” at mailing address “100 Apple Street, Cupertino, Calif.”, but the information in the database 261 indicates that the name is “William Smith” in the same mailing address, then the variance value 263 will be small in value (e.g., 2%). Therefore, similarities in the name of the customer and the name in the database 261 (where the names vary based on accepted variations in the particular name) may result in a small value for the variance value 263. On the other hand, as another example, if the information in the database 261 indicates the name as “Janet Jones” in the same mailing address, then there is a potential mismatch and as a result, the variance value 263 will be greater (higher) in value (e.g., 95%) due to a likely fraudulent activity related to the order 110. As another example, if the phone number of the shipping address is a mobile phone number (e.g., cellular phone number) as indicated in the database 261, then the variance value 263 will be greater in value due to a likely fraudulent activity related to the order. Other mismatches of information from the database 261 and/or information indicative of potential fraud can be used to determine the variance value 263.

Therefore, an embodiment of the invention permits the use of the third-party service 134 to further investigate the customer 105 information and identity if, for example, the provided customer information does not match the customer file from the AVS service 260. As a result, the third-party service 134 provides a supplemental address verification feature. This feature reduces the likelihood of the call center traffic that is related to AVS mismatches.

The variance value 263 and the information provided in the order 110 by the customer 105 are then transmitted to the rule-based fraud detection tool 133 to further check the order 110 for potential fraud. A second set of outsort rules 265 will check the variance value 263 and the information provided by the customer 105 of the order 110. If an outsort rule 265 does not fire in the rule-based fraud detection tool 133, then the order is accepted (266).

On the other hand, if an outsort rule 265 fires in the rule-based fraud detection tool 133, then the order 110 is placed in a second outsort queue 267, and a fraud analyst 268 will evaluate the order 110 for potential fraud and determine if the order should be accepted (269) or rejected (270).

The outsort rules 265 may be programmed to fire if, for example, the variance value 263 is at a high value (e.g., 50% or greater in value). The outsort rules 265 may also be set to fire if, for example, the value of the order 110 is above a threshold dollar amount (e.g., the order 110 has an amount greater than $2,000.00). The outsort rules 265 may be set to fire based upon other suitable criteria related to the order and/or customer 105.

One method of examining an order 110 for potential fraud is by determining if the order 110 is a high risk order, medium risk order, or low risk order. An order is outsorted in outsort queue 267, where the order can then be evaluated for risk related to fraudulent activity. After an order 110 is categorized as a high risk order, medium risk order, or low risk order, then a set of information may be used by the fraud analyst 268 to determine if the order is related to a potential fraudulent activity based upon the categorization of the order 110. Of course, other suitable methods may be used to evaluate an order for potential fraud activity, after the order 110 is placed in the outsort queue 267.

Therefore, an embodiment of the invention permits the use of the third-party server 134 to advantageously reduce the number of orders 110 that will need to be examined based upon the risk factor in the outsort queue 267. This reduction leads to less cost because the volume of orders to be examined in the outsort queue 267 by fraud analyst 268 may be reduced.

The various engines and modules discussed herein may be, for example, software, commands, data files, programs, code, firmware, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for supplemental address verification for fraud prevention, the method comprising:
receiving an incoming order from a customer;
validating a credit card of the customer with an issuing financial institution;
comparing information related to the incoming order with negative files;
comparing information related to the incoming order with general fraud patterns; and
if an outsort rule fires, then using a third-party service to further analyze the incoming order for potential fraud.

2. The method of claim 1, wherein the action of using the third-party comprises:
providing a variance value that is indicative of the variance between information provided by the customer and information in a database of the third-party service.

3. The method of claim 2, wherein the variance value is small in value if a name provided by the customer is similar to a name of the customer in the database.

4. The method of claim 2, wherein the variance value is higher in value if a name provided by the customer does not match a name of the customer in the database.

5. The method of claim 2, wherein the variance value is higher in value if a phone number of the shipping address provided by the customer is a mobile phone number.

6. The method of claim 2, further comprising:
using the variance value, along with information provided by the customer, to further check the order for potential fraud.

7. The method of claim 6, further comprising:
using the variance value and the information of the customer to determine if the order will require evaluation by a fraud analyst.

8. The method of claim 1, wherein the order is received via an online shopping website.

9. The method of claim 1, wherein the order is received via a call center.

10. An apparatus for supplemental address verification for fraud prevention, the apparatus comprising:
validation tool configured to receive an incoming order from a customer and to validating a credit card of the customer with an issuing financial institution;
a fraud shield tool configured to compare information related to the incoming order with negative files;
an electronic commerce rule-based fraud detection tool configured to compare information related to the incoming order with general fraud patterns; and
a third-party service configured to further analyze the incoming order for potential fraud, if an outsort rule fires.

11. The apparatus of claim 10, wherein the third-party provides a variance value that is indicative of the variance between information provided by the customer and information in a database of the third-party service.

12. The apparatus of claim 11, wherein the variance value is small in value if a name provided by the customer is similar to a name of the customer in the database.

13. The apparatus of claim 11, wherein the variance value is higher in value if a name provided by the customer does not match a name of the customer in the database.

14. The apparatus of claim 11, wherein the variance value is higher in value if a phone number of the shipping address provided by the customer is a mobile phone number.

15. The apparatus of claim 10, wherein the electronic commerce rule-based fraud detection tool is configured to use the variance value, along with information provided by the customer, to further check the order for potential fraud.

16. The apparatus of claim 15, wherein the electronic commerce rule-based fraud detection tool is configured to use the variance value and the information of the customer to determine if the order will require evaluation by a fraud analyst.

17. The apparatus of claim 10, wherein the order is received via an online shopping website.

18. The apparatus of claim 10, wherein the order is received via a call center.

19. An apparatus for supplemental address verification for fraud prevention, the apparatus comprising:
means for receiving an incoming order from a customer;
means for validating a credit card of the customer with an issuing financial institution;
means for comparing information related to the incoming order with negative files;
means for comparing information related to the incoming order with general fraud patterns; and
means for using a third-party service to further analyze the incoming order for potential fraud, if an outsort rule fires.

20. The apparatus of claim 19, wherein the means for using the third-party is configured to provide a variance value that is indicative of the variance between information provided by the customer and information in a database of the third-party service.

21. An article of manufacture, comprising:
a machine-readable medium having stored thereon instructions to:
receive an incoming order from a customer;
validate a credit card of the customer with an issuing financial institution;
compare information related to the incoming order with negative files;
compare information related to the incoming order with general fraud patterns; and
use a third-party service to further analyze the incoming order for potential fraud, if an outsort rule fires.
